(19) United States
(12) Patent Application Publication
(10) Pub. No.: US 2013/0062922 A1
(43) Pub. Date: Mar. 14, 2013

(54) Leg Elevation Device

(71) Applicant: Christopher S. Dickson, Greensboro, NC (US)

(72) Inventor: Christopher S. Dickson, Greensboro, NC (US)

(21) Appl. No.: 13/229,979

(22) Filed: Sep. 12, 2011

(51) Int. Cl. A47C 7/50; A61G 15/12

(52) U.S. Cl. 297/423.1; 128/845

(57) ABSTRACT

A therapeutic leg elevation device and an associated treatment method are disclosed. The device includes a first inclined surface for supporting a patient's thigh and that tilts the thigh at an angle above horizontal that is also less than an angle that can kink the femoral vein. A second inclined surface supports the patient's lower leg and also tilts the lower leg above the horizontal at an angle sufficient to permit gravity to augment blood flow. The first and second surfaces define an angle that positions the knee and lower leg at an angle that relaxes the hamstring and gastrocnemius muscle for comfort and prevents the popliteal vein from being compressed by the tibia. The second inclined surface has a limited length that permits a patient's feet to extend over the end of the second surface to prevent pressure on the heel. The device includes an inflatable interior component and a cushion layer covering the inflatable interior component.

### BACKGROUND

The invention relates to the medical advantages of elevating a person's legs. Intermittent leg elevation is recommended for treatment of a number of vascular diseases including (but not limited to): chronic venous insufficiency; varicose veins; deep vein thrombosis; and superficial thrombophlebitis.

Leg elevation is also recommended for primary and secondary lymphedema and is therapeutic for post operative patients, including hip or knee replacement; vein harvest; hernia repair; surgery or radiation therapy for cancer in the pelvic area; and foot surgery.

Leg elevation is also recommended for athletes with leg injuries, or to assist with recovery after intense athletic training. Leg elevation can also address chronic back pain, and can provide relief during pregnancy and to persons with jobs which require long periods standing up.

Although numerous devices, including patented devices, have been used for leg elevation, many fail to address some or all of the factors that have been identified as beneficial. As one factor, if the thigh is tilted improperly, the femoral vein can become kinked (blocked). As another factor, failure to properly elevate the lower portion of the leg can reduce or eliminate the advantages of gravity flow in the elevated leg. As another factor, if the lower leg and upper leg are positioned at improper angles (i.e., an improper bend at the knee), the hamstring and gastrocnemius muscles can be stretched inappropriately and the tibia can compress the popliteal vein.

Apart from these medical issues, many leg elevation devices are necessarily rather large and accordingly require significant amounts of space for transportation, storage, and use. This adds to the inconvenience and in some cases the expense of using the device.

### SUMMARY

The invention is a three dimensional solid shape that properly elevates the legs for therapy for the listed (and other) purposes.

In one aspect, the leg elevation device includes a first inclined surface for supporting a patient's thigh in which the surface tilts the thigh at an angle above horizontal that is also less than an angle that can kink the femoral vein. A second inclined surface supports the patient's lower leg and also tilts the lower leg above the horizontal at an angle sufficient to permit gravity to augment blood flow. The first and second surfaces define an angle that positions the knee and lower leg at an angle that relaxes the hamstring and gastrocnemius muscle (for comfort) and prevents the popliteal vein from being compressed by the tibia. The second inclined surface has a limited length that permits a patient's feet to extend over the end of the second surface to prevent pressure on the heel. The device includes an inflatable interior component and a cushion layer covering the inflatable interior component.

In another aspect the leg elevation device includes a first inclined surface which tilts the thigh about 40° above horizontal, with the first inclined surface being slightly concave to contour the shape of the thigh muscles to equally distribute pressure. A second inclined surface supports the patient's lower legs and tilts lower leg 15° above the horizontal. The second surface is also concave in order to contour to the shape of the muscles and equally distribute pressure and avoid pressure points. The second inclined surface has a limited length that permits a patient's feet to extend over the end of the second surface to prevent pressure on the heel. The leg elevation device includes an inflatable interior bladder, a cushion layer over the bladder and a removable cover over the cushion layer.

In another aspect, the invention is a method of therapeutically treating a patient. In this aspect, the invention includes the steps of positioning a patient face up with the patient's back in a generally horizontal position, tilting the patient's thigh above horizontal at an angle that avoids pinching femoral vein, elevating the patient's lower leg above horizontal at an angle sufficient to permit gravity to augment blood flow, and that forms an angle between the thigh and the lower leg that relaxes the hamstring and gastrocnemius muscles and prevents the popliteal vein from being compressed by the tibia, while avoiding contact with the patient's feet, and by placing the patient's thigh and lower leg on respective surfaces that position the thigh and lower leg at the designated angles.

The foregoing and other objects and advantages of the invention and the manner in which the same are accomplished will become clearer based on the followed detailed description taken in conjunction with the accompanying drawings.

### BRIEF DESCRIPTION OF THE DRAWINGS

FIG. 1 is a first perspective view of the leg elevation device.

FIG. 2 is a schematic diagram of some of the defined angles in one embodiment of the leg elevation device.

FIG. 3 is another perspective view of the leg elevation device.

FIG. 4 is a cross-sectional view taken along lines 4-4 of FIG. 3.

FIG. 5 is a cross-sectional view taken along lines 5-5 of FIG. 3.

FIG. 6 is a cross-sectional view taken along lines 6-6 of FIG. 3.

FIG. 7 is a second perspective view of the leg elevation device.

FIG. 8 is a third perspective view of the leg elevation device.

### DETAILED DESCRIPTION

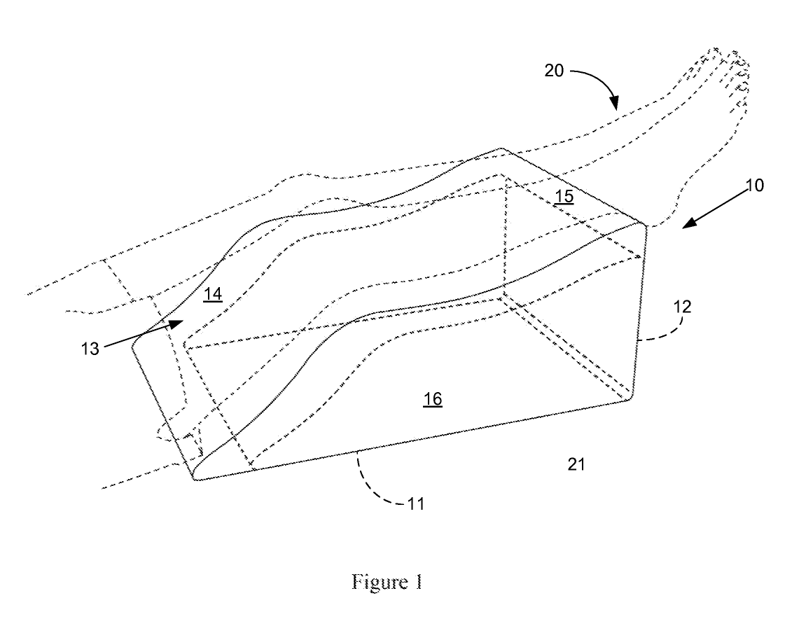

FIG. 1 is a perspective view of a leg elevation device broadly designated at 10 according to the present invention and illustrated in context. In the illustrated embodiment, the device 10 is an irregular solid polygon that includes a generally rectangular horizontal base 11, a generally rectangular vertical rear surface 12, and a contoured upper portion broadly designated at 13 which includes a first inclined surface 14 and a second inclined surface 15. Two generally matching irregular polygon side portions 16 and 17 (only one of which is visible in FIG. 1) complete the overall shape.

In use, one or both of a patient's legs (broadly designated at 20) rests on the leg elevation device 10 in the illustrated manner.

In the exemplary embodiments, the first inclined surface 14 supports the patient's thigh and tilts the thigh at an angle above horizontal that is less than an angle that can kink (pinch) the femoral vein. In exemplary embodiments, the first surface is inclined at an angle of between about 37° and 43° above horizontal with 40° being generally most advantageous to the patient.

The second inclined surface 15 supports the patient's lower leg and tilts lower leg above horizontal at an angle sufficient to permit gravity to augment blood flow. The second surface 15 is inclined at an angle of between about 12° and 18° above horizontal with an angle of 15° being generally advantageous to most patients.

Additionally, the first and second surfaces define an angle (i.e., between the surfaces) that positions the knee and lower leg at an angle that relaxes the hamstring and gastrocnemius muscles (for comfort) and prevents the popliteal vein from being compressed by the patient's tibia. The defined angle between the first and second surfaces 14, 15 is maintained at between about 22° and 28° with an angle of 25° being most helpful to typical patients.

The second inclined surface 14 also has a limited length that permits a patient's feet to extend over the end of the second surface 15 to prevent pressure on the patient's heel. The appropriate length for the second inclined surface 15 can be selected according to the average length of an adult lower leg, or to the particular length of a patient's leg. Stated differently, the overall proportion of the device 10, including the length of the second inclined surface 15, can be increased or decreased as necessary to fit average patients or individual patients, and no reason exists for the leg elevation device 10 to be limited to a single size provided that the functional requirements are otherwise met.

The first inclined surface 14 is slightly concave to contour the shape of the thigh muscles to equally distribute pressure; and the second inclined surface 15 is also concave in order to contour to the shape of the muscles and equally distribute pressure and avoid pressure points. In contrast, flat surfaces (common in a number of leg elevation devices) create pressure points which are uncomfortable and can cause pressure sores.

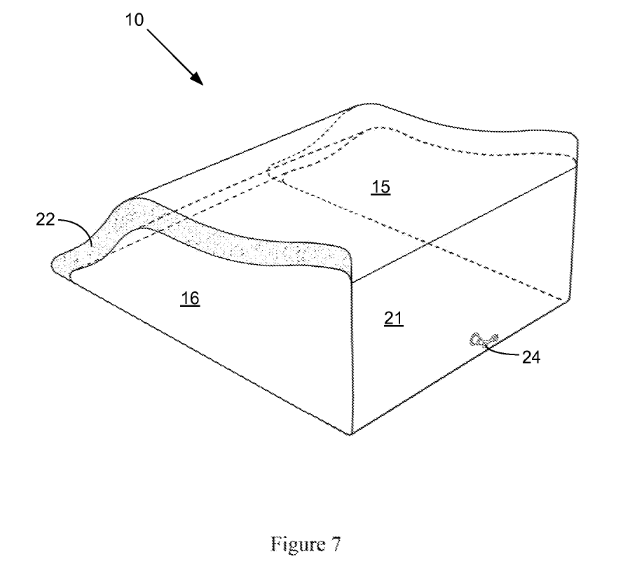

The leg elevation device 10 also includes an inflatable component 21 shown in dotted lines in FIG. 1. A cushion layer 22 (e.g., FIG. 7) covers the inflatable component 21, and in exemplary embodiments covers the top portion of the inflatable component 21. In exemplary embodiments the inflatable component 21 is a bladder and the cushion layer 22 is about 2 inches thick. Again, however, it will be understood that each of these dimensions can be increased or decreased for various functional purposes. For example, a larger bladder with a thinner cushion may provide advantages for reduced size in storage. An embodiment with a smaller bladder and a thicker cushion can provide advantages for structural or therapeutic purposes. In general, limiting the foam layer 22 to the top of the device 10 maintains advantages for breakdown, travel, and storage. Additionally, in most circumstances the patient's legs are the only body parts in contact with the top surface.

In exemplary embodiments, the bladder 21 has an inflated shape that is congruent with the shape of the overall leg elevation device 10.

As illustrated, the leg elevation device 10 has a width sufficient to support both of a patient's legs, but it will be understood that a narrower embodiment with the same advantages could be used to support a single leg while otherwise saving space.

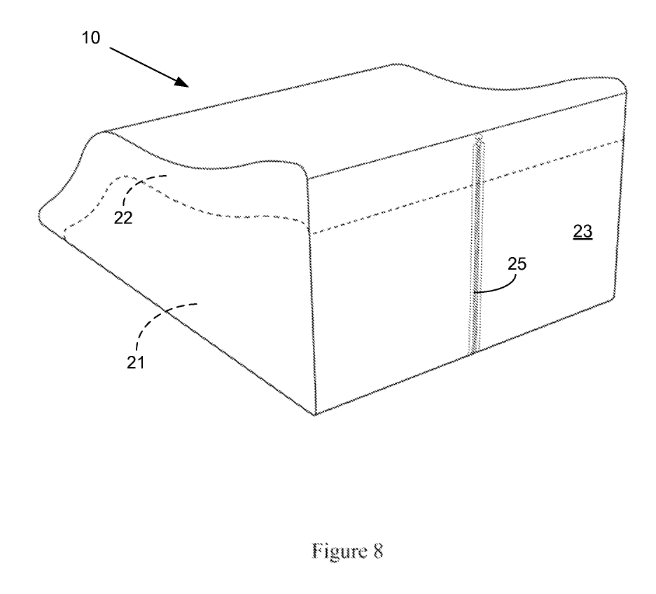

In exemplary embodiments, the leg elevation device further includes a removable cover 23 (e.g., FIG. 8).

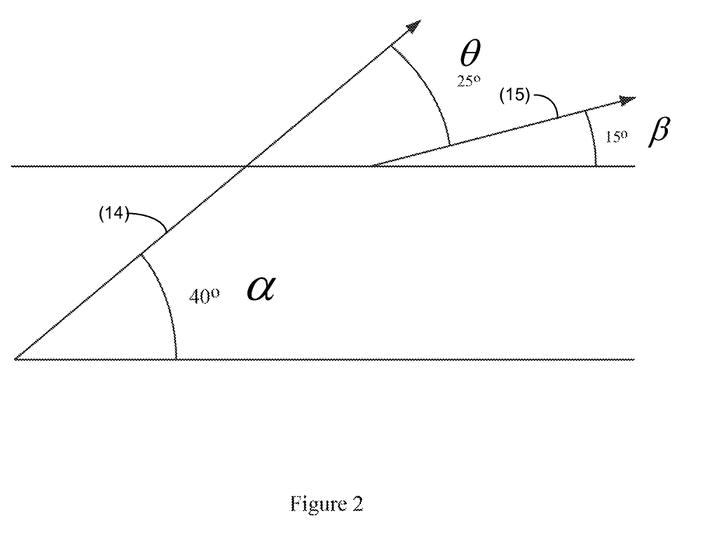

FIG. 2 is a schematic diagram illustrating some of the structural and functional aspects of the invention. FIG. 2 illustrates that the first inclined surface 15 forms an angle (α) of 40° with respect to the horizontal and the second inclined surface 15 forms an angle (β) of 15° with the horizontal. These two angles α, β define an angle (θ) of 25° between them that provides the described functional advantages.

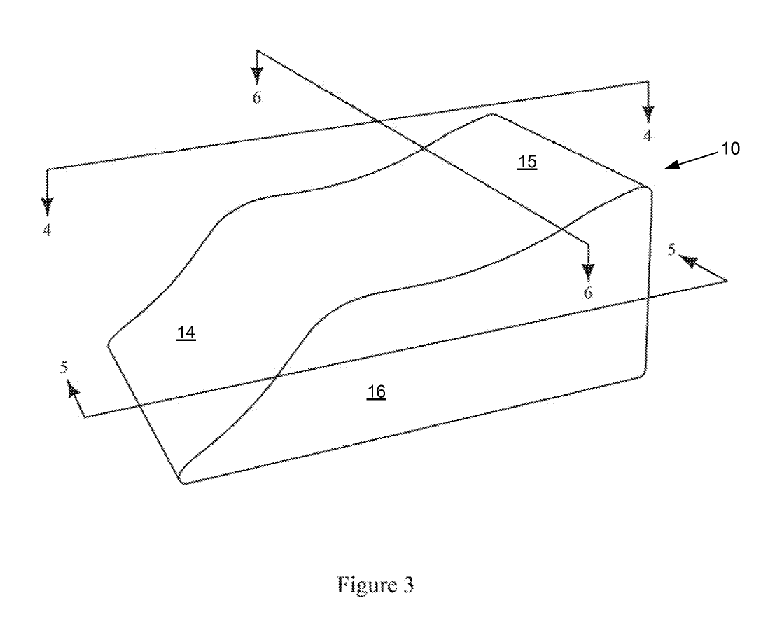

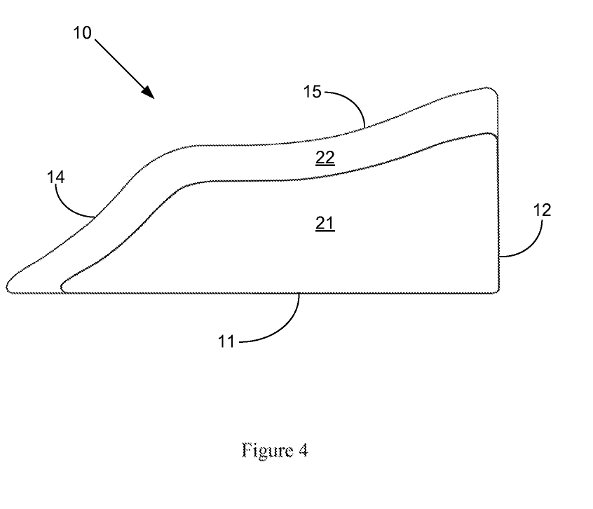

FIG. 3 is another perspective view of the leg elevation device 10 of the invention illustrating only the exterior shape and providing a context for the cross-sectional views of FIGS. 4, 5, and 6. FIG. 3 accordingly provides a view of one side 16 of the irregular solid polygon along with the first inclined surface 14 and the second inclined surface 15.

FIG. 4 is a cross-sectional view taken along lines 4-4 of FIG. 3. FIG. 4 illustrates the rectangular base 11, the rear surface 12, the first inclined surface 14, and the second inclined surface 15. In the cross-sectional view of FIG. 4 the inflatable bladder 21 is outlined in solid lines and the top portion of the bladder 21 is covered by the cushion layer 22.

In exemplary embodiments the cushion layer 22 can be any material that provides the necessary functional support and physical comfort for the patient consistent with the bladder and the overall structure of the device 10. In most typical embodiments, the cushion layer 22 will be formed of polymeric foam. Polyurethane memory foam is typical because its chemistry is well understood in the art along with the manner in which cell size and other properties can be controlled. Memory foam is also quite comfortable and conforms easily to a user's legs, regardless of differences in shape. In typical embodiments, the memory foam cushion layer 22 is glued to the inflatable component 21 with a suitable adhesive.

As used herein, the term “memory foam” refers to polyurethane foams for which the viscosity and density allow the foam to quickly conform to the shape of a body pressing against it, and to return to its original shape once the pressure is removed. Memory foams are also described as being viscoelastic, a term that typically refers to a substance that has both viscous and elastic properties. Viscous means having a relatively high resistance to flow or the sticky properties of an adhesive, or both. Elastic means an object that easily resumes its original shape after being stretched or expanded.

Nevertheless, the cushion 22 can also be formed of any other polymer foam (or equivalent material) that otherwise meets the functional requirements, including rubber, gel, polyvinyl chloride (“PVC”), and other polymers.

The properties of foam can be controlled, and therefore selected for function, based upon a number of well understood factors. As described herein, these factors are exemplary, but not limiting with respect to foams and foam performance.

Density refers to the mass per unit volume and affects the durability and support of the foam. Foams with higher density will tend to retain their original properties in a more satisfactory manner.

Foam firmness is independent of foam density and typically relates to comfort. Firmness is often measured by indentation force deflection in which foam is indented to 25% of its original height.

Foam can also be characterized by its support factor which typically represents the difference between a 25% foam indentation and a 65% foam indentation. The ratio between these two indentations is referred to as the foam support factor. Foams with a higher support factor are generally considered advantageous.

For some purposes foams are characterized by flex fatigue which represents the foam's performance after being compressed many times (i.e., thousands). The support characteristics of the foam are then re-measured and compared to the original support factor to give an indication of the foam's quality.

Depending upon end use, foams are also subjected to testing and measurement of their roller shear (by rolling a weight over a foam sample from two directions for many thousand cycles) and tear strength. Resilience is a measure of the surface elasticity of foam and is measured by dropping an object (a steel ball) onto the foam and measuring the bounce.

Foams can also be evaluated for airflow because foam performance tends to be best when airflow is maximized. In addition, foams are also selected depending upon end use to minimize or eliminate the likelihood that they will burn (combustibility), leach chemicals, or have other characteristics that may be consistent or inconsistent with the end use.

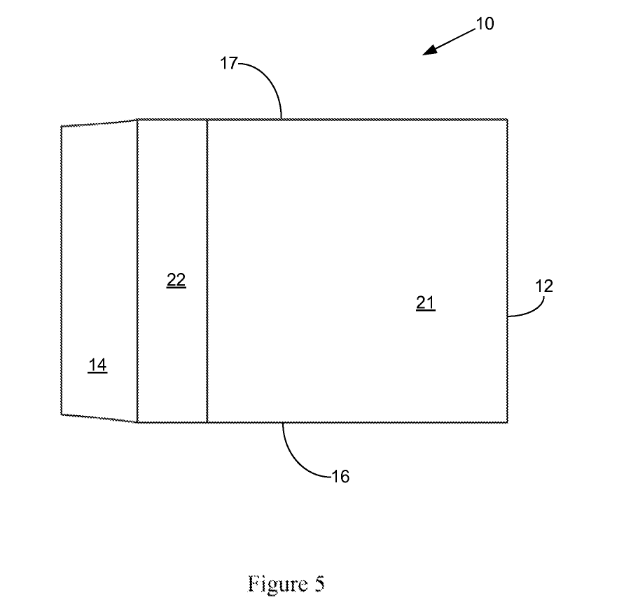

FIG. 5 is a cross-sectional view taken horizontally across the device 10; i.e., along lines 5-5 of FIG. 3. FIG. 5 illustrates the rear surface 12, the side surfaces 16, 17, the first inclined surface 14, a portion of the cushion layer 22, and the interior bladder 21.

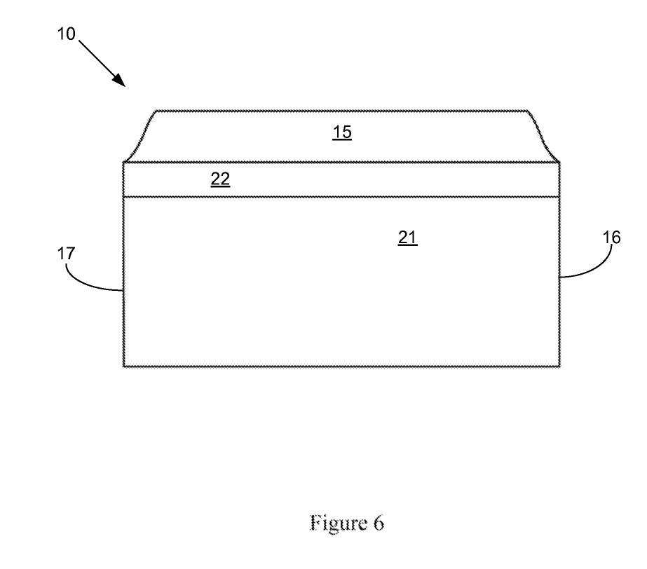

FIG. 6 is a cross-sectional view taken along lines 6-6 of FIG. 3. FIG. 6 illustrates the second inclined surface 15, the side portions 16, 17, the cushion layer 22, and the interior inflatable bladder 21.

FIG. 7 is a perspective view of the leg elevation device 10. The view in FIG. 7 is taken without any fabric cover to illustrate aspects of the bladder 21, the cushion layer 22, and the removable cover 23. FIG. 7 also shows that the bladder 21 can be inflated through an appropriate valve 24 which is illustrated as a simple inflation valve. It will be understood, however, that this is exemplary rather than limiting. In addition to a simple valve that can be inflated for example by mouth, the valve 24 could be the type that is inflated by a simple mechanical pump or from a supply of inert gas or compressed air.

In exemplary embodiments, the majority of the support is provided by the inflatable bladder 21. The inflatable nature of the device is an improvement over current products which, typically being entirely solid (foam), are difficult to pack or carry for travel. Because of their size, large, solid devices are also expensive to transport and stock in stores. The inflatable bladder 21 permits the invention to be deflated for travel, shipping or storage.

The bladder 21 can be formed of any material that can be inflated and maintain its inflation for a reasonable length of time (i.e., hours, days, or longer). The bladder 21 can be a simple inflatable bag structure (e.g., a polyethylene bag) or can include more complex structures such as internally baffled, multiple chambers of latex (vulcanized rubber) or vinyl with bonded fabric (e.g. cotton) exteriors.

In FIG. 7, the cushion layer 22 is shaded to help illustrate the foam. The other portions of the leg elevation device 10 carry the same reference numerals as in the other drawings.

FIG. 8 is a rear perspective view of the leg elevation device 10 with a fabric cover in place. The cover 23 can be permanent or removable. If removable, the cover can be manufactured in a fitted sense analogous to a mattress cover (i.e., using elastic) or with zippers or equivalent fixtures of the type typically used to enclose upholstery foam in furniture. FIG. 8 illustrates an embodiment with a zipper 25. In exemplary embodiments the cover 23 extends over some, and preferably all, of the bottom surface (the rectangular base 11) of the device 10 because the fabric can help prevent the device 10 from sliding while in use. These choices (including other means for preventing slipping) can be made by the skilled person and without undue experimentation.

The cover 23 can be made of any appropriate material with breathable fabrics being typically preferred for comfort. As is the case with fabrics used with other analogous items (such as furniture cushions), the fabric can be woven or knitted, and in some cases a nonwoven structure could be appropriate. The fabric can be formed of yarns that are selected for their desired characteristics. For example, cotton or appropriately textured synthetics can increase comfort, while more robust synthetics can increase durability and strength. Again, these choices can be made based on the end use and do not otherwise limit the structure and function of the invention.

The device 10 can be produced in a variety of sizes, and it is expected that three basic sizes will be able to cover over 90% of the potential users. A pediatric size (or sizes) can be provided for children and extra large sizes (“big and tall”) can be provided for athletes given its potential for such users. As the size increases, the side panels increase in size to maintain the same functional shape. As a result, a size change affects more than just the length of the upper surface 15 and changes in size are analogous to zooming in or out of the side view (e.g. FIG. 4) of the device. The width can typically stay the same, but can be changed to suit particular needs, including those of larger persons.

In another aspect, the invention is a method of therapeutically treating a patient by positioning the patient face up with the patient's back in a generally horizontal position, tilting the patient's thigh above horizontal at an angle that avoids pinching the femoral vein, elevating the patient's lower leg also above horizontal and at an angle sufficient to permit gravity to augment blood flow, and that forms an angle between the thigh and the lower leg that relaxes the hamstring and gastrocnemius muscles and prevents the popliteal vein from being compressed by the tibia. The method avoids contact with the patient's feet and is carried out by placing the patient's thigh and lower leg on respective surfaces that position the thigh and lower leg at the designated angles.

In helpful embodiments, the thighs are tilted at an angle of between about 37° and 43° above horizontal with 40° being most helpful. The lower legs are tilted at an angle of between about 12° and 18° with about 15° being most helpful. In conjunction with each of these positions, the angle between the thigh and the lower leg is maintained at between about 22 and 28°, with 25° being particularly helpful.

The method can be carried out by positioning the patient on a leg elevation device including a device as described herein that includes the two inclined surfaces, the inflatable interior component, and the cushion layer covering the inflatable interior component.

In the drawings and specification there has been set forth a preferred embodiment of the invention, and although specific terms have been employed, they are used in a generic and descriptive sense only and not for purposes of limitation, the scope of the invention being defined in the claims.

1. A leg elevation device comprising:
a first inclined surface for supporting a patient's thigh that tilts the thigh at an angle above horizontal that is also less than an angle that can kink the femoral vein;
a second inclined surface for supporting the patient's lower leg that also tilts the lower leg above the horizontal at an angle sufficient to permit gravity to augment blood flow;
said first and second surfaces defining an angle that positions the knee and lower leg at an angle that relaxes the hamstring and gastrocnemius muscle and prevents the popliteal vein from being compressed by the tibia;
said second inclined surface having a limited length that permits a patient's feet to extend over the end of said second surface to prevent pressure on the heel;
an inflatable interior component; and
a cushion layer covering said inflatable interior component.

2. A leg elevation device according to claim 1 wherein said first surface is inclined at an angle of between about 37° and 43° above horizontal.

3. A leg elevation device according to claim 1 wherein said second surface is inclined at an angle of between about 12° and 18° above horizontal.

4. A leg elevation device according to claim 1 wherein said first and second surfaces define an angle of between about 22° and 28°.

5. A leg elevation device according to claim 1 wherein:
said inflatable interior component is a bladder; and
said cushion covering is about 2 inches thick.

6. A leg elevation device according to claim 1 further comprising a removable cover.

7. A leg elevation device according to claim 1 that has a width sufficient to support two legs.

8. A leg elevation device comprising:
a first inclined surface which tilts the thigh about 40° above horizontal;
said first inclined surface being slightly concave to contour the shape of the thigh muscles to equally distribute pressure;
a second inclined surface for supporting the patient's lower legs which tilts lower leg 15° above the horizontal;
said second surface also being concave in order to contour to the shape of the muscles and equally distribute pressure and avoid pressure points;
said second inclined surface having a limited length that permits a patient's feet to extend over the end of said second surface to prevent pressure on the heel;
an inflatable interior bladder;
a cushion layer over said bladder; and
a removable cover over said cushion layer.

9. A leg elevation device according to claim 8 wherein said removable cover is a fabric cover.

10. A leg elevation device according to claim 8 wherein said cushion layer is selected from the group consisting of rubber, gel, polyurethane, PVC, viscoelastic foams, memory foam, and high density foam.

11. A leg elevation device according to claim 10 wherein said cushion layer comprises a 2 inch thick layer of a polymeric foam.

12. A leg elevation device according to claim 8 wherein said interior bladder has an inflated shape congruent with the shape of the overall leg elevation device.

13. A leg elevation device according to claim 8 that has a width sufficient to support two legs.

14. A method of therapeutically treating a patient comprising:
positioning a patient face up with the patient's back in a generally horizontal position;
tilting the patient's thigh above horizontal at an angle that avoids pinching femoral vein;
elevating the patient's lower leg above horizontal at an angle sufficient to permit gravity to augment blood flow, and that forms an angle between the thigh and the lower leg that relaxes the hamstring and gastrocnemius muscles and prevents the popliteal vein from being compressed by the tibia;
while avoiding contact with the patient's feet; and
by placing the patient's thigh and lower leg on respective surfaces that positions the thighs and lower legs at the designated angles.

15. A method according to claim 14 comprising elevating both of a patient's legs.

16. A method according to claim 14 comprising titling the thighs at an angle of between about 37° and 43° above horizontal.

17. A method according to claim 14 comprising tilting the lower legs at an angle of between about 12° and 18°.

18. A method according to claim 16 comprising maintaining the angle between the thigh and lower leg at between about 22° and 28°.

19. A method according to claim 15 comprising positioning the patient on a leg elevation device.

20. A method according to claim 19 comprising positioning the patient on a leg elevation device that includes at least two inclined surfaces, an inflatable interior component, and a cushion layer covering said inflatable interior component.
